(19) United States
(12) Patent Application Publication
(10) Pub. No.: US 2018/0298753 A1
(43) Pub. Date: Oct. 18, 2018

(54) CONTROL SYSTEM AND METHOD FOR CONTROLLING OPERATION OF AN UNDERGROUND MINING MACHINE

(71) Applicant: Caterpillar Global Mining Europe GmbH, Lunen (DE)

(72) Inventors: Carl John Moberg, Dunlap, IL (US); Oliver Kortmann, Werne (DE); Thomas Temmann, Werne (DE); Konstantin Halle, Selm (DE); Bjoern-Andre Huehn, Essen (DE); Carsten Butz, Dortmund (DE); Frank Kühnemund, Dresden (DE)

(73) Assignee: Caterpillar Global Mining Europe GmbH, Lunen (DE)

(21) Appl. No.: 15/490,542

(22) Filed: Apr. 18, 2017

(51) Int. Cl. E21C 35/24; E21C 25/16; E21C 31/02; E21C 41/00; G01L 5/00

(52) U.S. Cl. CPC E21C 35/24; E21C 25/16; G01L 5/0076; E21C 41/00; E21C 31/02

(57) ABSTRACT

A control system for controlling operation of a cutter motor and a cutter boom movement mechanism of a machine includes a sensor that measures an amount of load associated with the cutter motor. A controller determines whether the load on the cutter motor is different from a cutter motor load limit. If so, the controller is configured to adjust a velocity of the cutter boom movement mechanism relative to a tip velocity of a rotary cutting tool associated with the machine based on the difference between the measured cutter motor load and the cutter motor load limit until a torque error of the cutter motor reaches a particular value, for instance, zero. Moreover, the controller may also adjust a current speed of the cutter motor in driving the rotary cutting tool based on the adjusted velocity of the cutter boom movement mechanism.

### TECHNICAL FIELD

The present disclosure generally relates to an underground machine. More particularly, the present disclosure relates to a control system and a method for controlling operation of a cutter motor and a cutter boom movement mechanism associated with a rotary cutting tool of the underground machine.

### BACKGROUND

An underground mining machine may be used for mining earth material/s including, but not limited to, ore, coal, other minerals or rock. In a traditional configuration of such a machine, the underground mining machine may typically include a carriage, a frame disposed on the carriage, a boom mounted to the frame using a swing mechanism, and a rotary cutter mounted to a free end of the boom.

In operation, the rotary cutter is configured to operably engage with a face of the mine for breaking off deposits of earth material/s that lie in the face of the mine. The swing mechanism may be configured to operably translate the boom relative to the frame so that the rotary cutter at the free end of the boom may be facilitated in penetrating the face of the mine. Moreover, with inclusion of the swing mechanism, the boom may be configured to, additionally or optionally, swivel relative to the frame so that a cutting portion of the rotary cutter can engage onto the face of the mine with maximum contact area at a given instant of time in operation of the machine.

Some control systems have been developed for implementation and use in such underground mining machines. For example, U.S. Pat. No. 4,322,113 (hereinafter referred to as “the '113 patent”) discloses an excavating machine having a carriage with a boom support. A cutter carrying boom is moveably supported by the boom support, and a means is provided for moving the boom relative to the carriage. A drive means is included with a sensing control means for controlling the movement of the boom relative to the carriage. The sensing control means senses a parameter proportional to the reaction cutting force on the cutter.

The '113 patent further discloses that control over the movement of the boom is provided in two alternative modes. A rate mode control for controlling the machine in accordance with a preselected rate of the output of the drive means is provided, as well as a load mode control in which the movement of the boom is controlled maintaining the reaction cutting force exerted by the cutter substantially at or below a certain value.

### SUMMARY OF THE DISCLOSURE

In an aspect of the present disclosure, a control system for controlling operation of a cutter motor and a cutter boom movement mechanism associated with a rotary cutting tool of a machine is provided. The control system includes at least one sensor disposed on the machine and associated with the cutter motor. The at least one sensor is configured to measure an amount of load associated with the cutter motor in operation.

The control system also includes a controller that is disposed in communication with the at least one sensor, the cutter motor, and the cutter boom movement mechanism. The controller is configured to determine whether the amount of load on the cutter motor is different than a cutter motor load limit. If the amount of load on the cutter motor is different than the cutter motor load limit, the controller is configured to adjust a velocity associated with the cutter boom movement mechanism in moving the rotary cutting tool relative to a tip velocity of the rotary cutting tool based on a torque error of the cutter motor, computed by the controller from the difference between the load on the cutter motor and the cutter motor load limit, until the torque error of the cutter motor reaches a particular value, for instance, zero.

The controller may compute a derated cutter motor load limit for the cutter motor from the cutter motor load limit by multiplying a maximum amount of rated torque available from the cutter motor with a torque derate factor. In turn, the controller may further compute an adjusted cutter motor load limit for the cutter motor from the derated cutter motor load limit by multiplying the derated cutter motor load limit with a maximum load percentage allowed for the cutter motor. The maximum load percentage allowed for the cutter motor would be pre-defined to the controller by way of a user input. This way, when the controller is required to determine if there is a torque error from a difference between the load on the cutter motor and the derated cutter motor load limit, the controller may do so by determining if there is a difference between the amount of load on the cutter motor and the adjusted cutter motor load limit.

Thereafter, the controller may determine a speed limit factor based on the torque error and a maximum allowable velocity of the cutter boom movement mechanism. The maximum allowable velocity of the cutter boom movement mechanism would be provided to the controller by way of an input command. This way, the controller would then be configured to adjust the velocity associated with the cutter boom movement mechanism on the basis of the determined speed limit factor.

If the torque error of the cutter motor is indicative of the measured load on the cutter motor being greater than the adjusted cutter motor load limit, then the controller is configured to adjust the velocity associated with the cutter boom movement mechanism by decreasing the velocity associated with the cutter boom movement mechanism until the torque error of the cutter motor reaches the particular value, for instance, zero. Also, when the controller decreases the velocity associated with the cutter boom movement mechanism, a rate of decrease in the velocity of the cutter boom movement mechanism may be proportional to the amount of load measured by the sensor being in excess of the adjusted cutter motor load limit.

If the torque error of the cutter motor is indicative of the measured load on the cutter motor being less than the adjusted cutter motor load limit, then the controller adjusts the velocity associated with the cutter boom movement mechanism by increasing the velocity associated with the cutter boom movement mechanism.

In a further aspect of this disclosure, upon adjusting a velocity associated with the cutter boom movement mechanism, the controller may also be configured to selectively adjust a current speed of the cutter motor in driving the rotary cutting tool. If the controller is configured to adjust the current speed of the cutter motor, then the controller may adjust the same based, at least in part, on the adjusted velocity of the cutter boom movement mechanism.

For adjusting the current speed of the cutter motor in driving the rotary cutting tool, the controller may determine if a cutter motor load control factor is between a minimum threshold value and a maximum threshold value, each of the minimum and maximum threshold values being pre-defined to the controller. Moreover, the controller would also determine if the cutter motor load control factor is stable for a pre-determined period of time. If so, the controller may compute a desired cutter motor speed by multiplying a maximum nominal cutter motor speed with a ratio between the velocity associated with the cutter boom movement mechanism prior to adjustment and the adjusted velocity of the cutter boom movement mechanism, and adjust the current speed of the cutter motor so as to approach the desired cutter motor speed.

If the controller determines the cutter motor load control factor is unstable within the pre-determined period of time, then the controller is configured to facilitate a continuation in the operation of the cutter motor at the current speed without adjustment being made to the current speed of the cutter motor.

Embodiments herein also disclose a method for controlling operation of the cutter motor and the cutter boom movement mechanism. Moreover, embodiments disclosed herein are also directed to an underground mining machine employing the control system of the present disclosure.

Other features and aspects of this disclosure will be apparent from the following description and the accompanying drawings.

### BRIEF DESCRIPTION OF THE DRAWINGS

FIG. 1 is a diagrammatic view of an exemplary underground mining machine, in which embodiments of the present disclosure can be implemented;

FIG. 2 is a schematic of a control system for controlling an operation of a cutter motor and a cutter boom movement mechanism of the exemplary machine of FIG. 1, in accordance with embodiments of the present disclosure;

FIG. 3 is an exemplary tabulation depicting various values of speed limit factors V_{LIM} for unique combinations of torque errors T_{E} and maximum allowable velocity V_{MAX} of the cutter boom movement mechanism, in accordance with embodiments of the present disclosure; and

FIG. 4 is a flowchart of a method depicting process steps in controlling operation of the cutter motor and the cutter boom movement mechanism of the exemplary machine of FIG. 1, in accordance with an embodiment of the present disclosure.

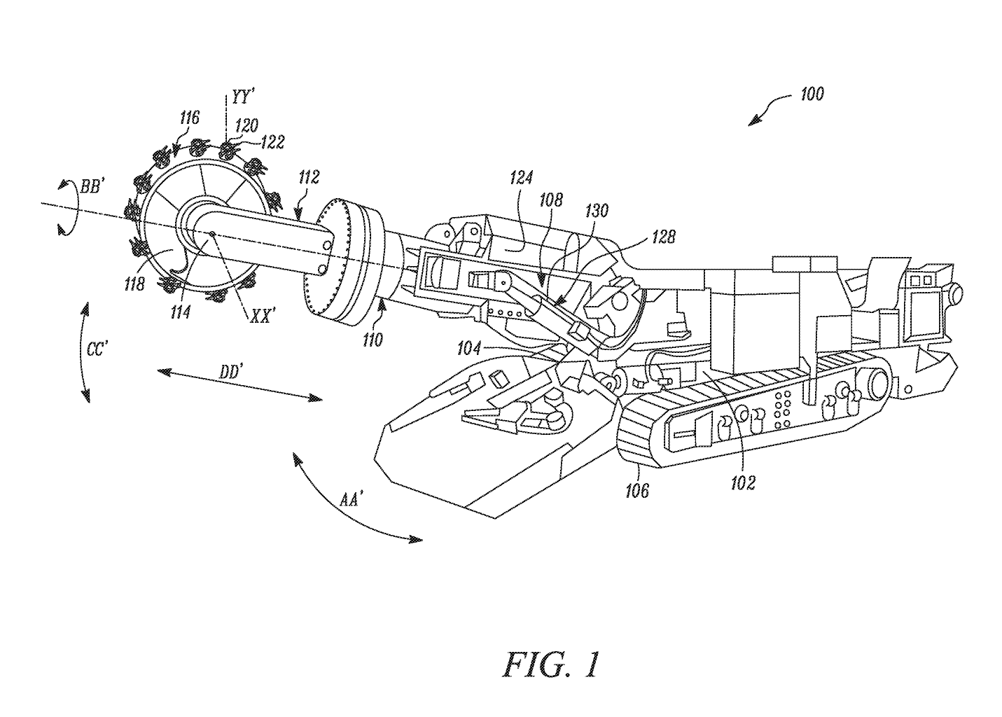

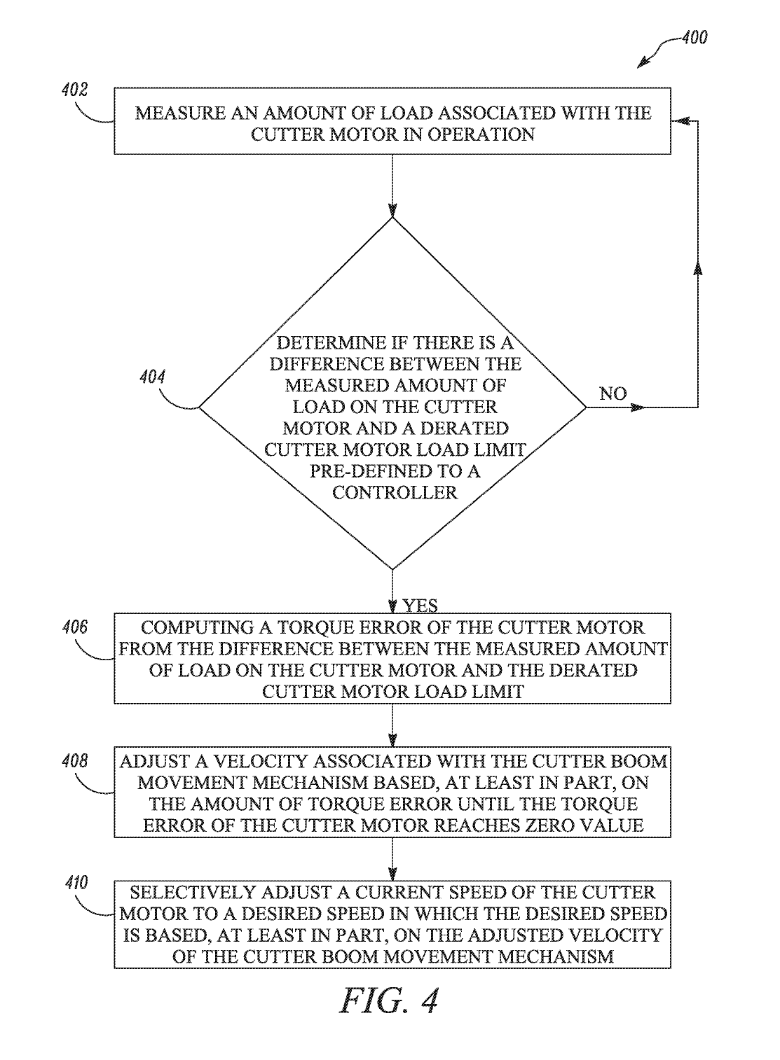

### DETAILED DESCRIPTION

Wherever possible, the same reference numbers will be used throughout the drawings to refer to same or like parts. FIG. 1 illustrates an exemplary machine 100 that is embodied in the form of an underground mining machine which, for the sake of convenience and simplicity, will hereinafter be referred to as “the machine” and denoted by identical numeral “100”. The machine 100 disclosed herein is embodied to perform, amongst other operations, a mining operation in which materials such as ore, coal, other minerals or rock are broken-off from the earth, such as from a face of a mine.

Although the present disclosure is explained in conjunction with the underground mining machine, a type of machine used herein is not to be construed as being limiting of this disclosure. Rather, it will be appreciated that embodiments of the present disclosure could be applied similarly to machines associated with other types of applications including, but not limited to, tunneling or other types of applications that are known to persons skilled in the art.

As shown, the machine 100 may include a frame 102. The frame 102 may be movably supported on a pair of ground engaging members 104, 106, which are embodied exemplarily in the form of crawlers as shown in the illustrated embodiment of FIG. 1.

The machine 100 also includes a boom 108 having a first portion 110 that is pivotally coupled to the frame 102. Further, the boom 108 has a second portion 112 that is rotatably coupled to the first portion 110. The second portion 112 is capable of co-axial rotation and translation in relation to the first portion 110.

Moreover, a free end 114 of the second portion 112 is adapted to support a rotary cutting tool 116 thereon. As shown in the illustrated embodiment of FIG. 1, the rotary cutting tool 116 may be implemented by a rotary head 118 bearing a series of cutting pods 120 thereon. Each of the cutting pods 120 includes a plurality of cutter bits 122 disposed thereon. It may be noted that a configuration of the rotary cutting tool 116 disclosed in the illustrated embodiment of FIG. 1 is non-limiting of this disclosure. Persons skilled in the art will acknowledge that the configuration of the rotary cutting tool 116 used on the machine 100 may vary from one application to another depending on specific requirements of an application.

The rotary cutting tool 116 disclosed herein is operatively driven by a cutter motor 124, for example, an Alternating Current (AC) drive motor. The cutter motor 124 is coupled to the rotary head 118 and each of the cutting pods 120 with the help of a gearbox (not shown) located in the second portion 112 of the boom 108. In operation, the gearbox is configured to help facilitate a transfer of drive power from the cutter motor 124 to the rotary head 118 and to each of the cutting pods 120 such that the rotary head 118 can operably rotate about its centric axis XX′ while each of the cutting pods 120 can rotate about their respective centric axes YY′.

Further, the machine 100 may include a cutter boom movement mechanism 128, for example, by use of suitable hydraulic devices (not shown) including, but not limited to, pumps, valves and other components known to persons skilled in the art. The control mechanism may include, at least in part, a pair of hydraulic cylinders 130 one of which is shown in the illustrated embodiment of FIG. 1.

As the first portion 110 of the boom 108 is pivotally connected to the frame 102, the cutter boom movement mechanism 128 can operatively swing, lift, and/or rotate the rotary cutting tool 116 relative to the frame 102 via movement of the first portion 110 of the boom 108 relative to the frame 102. Additionally, the cutter boom movement mechanism 128 can also perform an infeed movement of the second portion 112 of the boom 108 relative to the first portion 110 such that the rotary cutting tool 116 can be extended or retracted out of the face of the mine.

With continued reference to FIG. 1, the cutter boom movement mechanism 128 can swing the boom 108 and the rotary cutting tool 116 relative to the frame 102 by moving the boom 108 and the rotary cutting tool 116 in a leftward or rightward direction as shown with the help of directional arrows AA′. With regards to the rotating movement, it may be noted that the cutter boom movement mechanism 128 can rotate the rotary cutting tool 116 and the second portion 112 of the boom 108 in a clockwise or counterclockwise direction relative to the first portion 110 of the boom 108 and the frame 102 and this is shown accordingly with the help of directional arrows BB′. In regards to the lifting movement, the cutter boom movement mechanism 128 can raise or lower the boom 108 and the rotary cutting tool 116 relative to the frame 102 as shown in FIG. 1 with the help of directional arrows CC′. The lifting movement disclosed herein may be accomplished using the hydraulic cylinders 130 of the cutter boom movement mechanism 128 shown in FIG. 1.

With regards to the infeed movement, the cutter boom movement mechanism 128 can extend or retract the rotary cutting tool 116 into or out of a face of the mine by extending or retracting the second portion 112 of the boom 108 relative to the first portion 110 of the boom 108 and a direction of movement representative of the infeed movement is shown with the help of directional arrows DD′ in the view of FIG. 1.

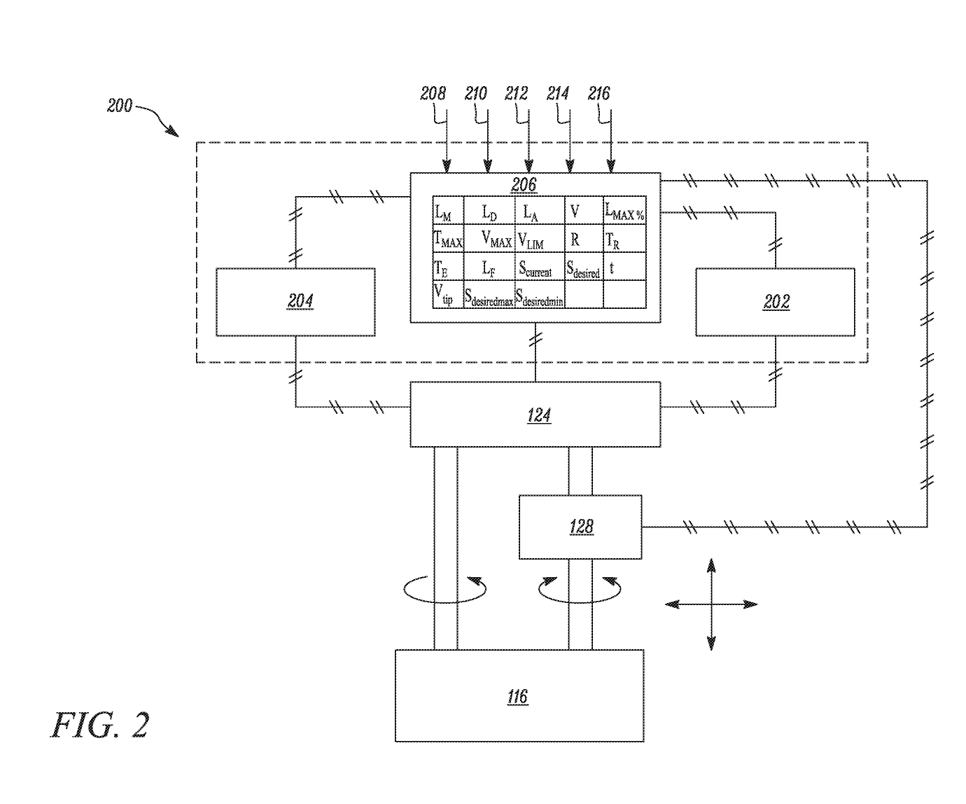

Referring now to FIG. 2, the present disclosure relates to a control system 200 that is configured to operatively control an operation of the cutter motor 124 and the cutter boom movement mechanism 128 associated with the rotary cutting tool 116 of the machine 100. The control system 200 may include at least one sensor disposed on the machine 100 and associated with the cutter motor 124. As shown in the schematic illustration of FIG. 2, the control system 200 includes a load sensor 202 that is disposed in communication with the cutter motor 124. The load sensor 202 is configured to measure an amount of load L_{M} associated with the cutter motor 124. Additionally or optionally, the control system 200 may include a speed sensor 204 disposed in communication with the cutter motor 124. The speed sensor 204 may be configured to output a speed of the cutter motor 124.

As shown, the control system 200 also includes a controller 206 that is disposed in communication with each of the speed sensor 204, the load sensor 202, the cutter motor 124, and the cutter boom movement mechanism 128. The controller 206 may receive the measured amount of load L_{M} from the load sensor 202. The controller 206 is then configured to determine if there is a difference between the amount of load L_{M} on the cutter motor 124 measured by the sensor 202 and a derated cutter motor load limit L_{D}, pre-defined to the controller 206. For instance, in some implementations, the derated cutter motor load limit L_{D} could be predetermined based on a cutter motor load limit and may be stored in a memory (not shown) associated with the controller 206. The controller 206 may include suitable components therein for determining the derated cutter motor load limit L_{D} directly from the cutter motor 124 itself. Alternatively, the derated cutter motor load limit L_{D} disclosed herein may be provided to the controller 206 by way of a user input, for example, user input 208.

If the controller 206 determines that there is a difference between the amount of load L_{M} on the cutter motor 124 as measured by the sensor 202 and the derated cutter motor load limit L_{D}, the controller 206 is configured to adjust a velocity V associated with the cutter boom movement mechanism 128 in moving the rotary cutting tool 116 relative to a velocity of a portion of the rotary cutting tool 116. In some implementations, the velocity of the portion of the rotary cutting tool 116 may be a tip velocity Vₜᵢₚ of the rotary cutting tool 116. In such implementations, the tip velocity Vₜᵢₚ of the rotary cutting tool 116 would be a value that is indicative of a velocity associated with rotational movement of the cutter bits 122 which may be generated as a result of rotating the rotary head 118 and the cutting pods 120 that support the cutter bits 122 thereon.

Moreover, the velocity V of the cutter boom movement mechanism 128 is adjusted by the controller 206 relative to the velocity of a portion of the rotary cutting tool 116 i.e., the tip velocity Vₜᵢₚ of the rotary cutting tool 116 based, at least in part, on a torque error T_{E} of the cutter motor 124, computed by the controller 206 from the difference between the load L_{M} on the cutter motor 124 measured by the sensor 202 and the derated cutter motor load limit L_{D} pre-defined to the controller 206 i.e., T_{E}=L_{M}−L_{D} . . . equation 1. The adjustment in the velocity V of the cutter boom movement mechanism 128 is carried out by the controller 206 until the torque error T_{E} of the cutter motor 124 reaches zero value i.e., T_{E}→0.

The controller 206 may compute the derated cutter motor load limit L_{D} for the cutter motor 124 by multiplying a maximum amount of rated torque T_{MAX} available from the cutter motor 124 with a pre-defined motor torque derate factor T_{R} i.e., L_{D}=T_{MAX}*T_{R} . . . equation 2.

In turn, the controller 206 may further compute an adjusted cutter motor load limit L_{A} for the cutter motor 124 from the derated cutter motor load limit L_{D} by multiplying the derated cutter motor load limit L_{D} with a maximum load percentage L_{MAX%} allowed for the cutter motor 124 i.e., L_{A}=L_{D}*L_{MAX%} . . . equation 3. The maximum load percentage L_{MAX%} allowed for the cutter motor 124 may be pre-defined to the controller 206 by way of another user input, for example, user input 210. For example, if the derated cutter motor load limit L_{D} is 3500 N-m, and the maximum load percentage L_{MAX%} allowed for the cutter motor 124 is 50%, then the adjusted cutter motor load limit L_{A}=3500 Nm*0.5=1750 N-m.

Although it is disclosed herein that the derated cutter motor load limit L_{D} and the adjusted cutter motor load limit L_{A} is computed by the controller 206 using equations 2 and 3 respectively, it may be noted that, in some embodiments, it has been contemplated to simply pre-set an initial value of cutter motor load limit at the controller 206. This initial value of cutter motor load limit may be lowered prior to being derated and adjusted by the controller 206 during an operation of the machine based on various factors including, but not limited to, failure modes, high operating temperatures of the cutter motor, and other factors in order to suit specific requirements of an application. Such lowered value of the initially pre-set cutter motor load limit may be used by the controller 206 for determining the derated and adjusted cutter motor limits L_{D}, L_{A} which are then used by the controller 206 for subsequently performing an adjustment to the velocity V of the cutter boom movement mechanism 128 relative to the velocity of a portion of the rotary cutting tool 116 i.e., the tip velocity Vₜᵢₚ of the rotary cutting tool 116 as disclosed earlier herein.

This way, when the controller 206 is required to determine if there is a torque error T_{E}, the controller 206 may do so by determining a difference between the amount of load L_{M} on the cutter motor 124 and the adjusted cutter motor load limit L_{A} i.e., T_{E}=L_{M}−L_{A} . . . equation 4 instead of determining the difference between the load L_{M} on the cutter motor 124 and the derated cutter motor load limit L_{D} i.e., T_{E}=L_{M}−L_{D} . . . equation 1.

Thereafter, the controller 206 may determine a speed limit factor V_{LIM} based on the torque error T_{E} and a maximum allowable velocity V_{MAX} of the cutter boom movement mechanism 128 set at the controller 206. The maximum allowable velocity V_{MAX} of the cutter boom movement mechanism 128 could be provided before-hand to the controller 206 by way of an input command, for example, user input 212. The controller may be configured to adjust the velocity V associated with the cutter boom movement mechanism 128 on the basis of the determined speed limit factor V_{LIM} for a given amount of torque error T_{E} and a given maximum allowable velocity V_{MAX} of the cutter boom movement mechanism 128 set at the controller 206.

If the torque error T_{E} of the cutter motor 124 is indicative of the measured load L_{M} on the cutter motor 124 being greater than the adjusted cutter motor load limit L_{A} i.e., if T_{E} is positive from L_{M}>L_{A}, then the controller 206 is configured to adjust the velocity V associated with the cutter boom movement mechanism 128 by decreasing the velocity V associated with the cutter boom movement mechanism 128 relative to the tip velocity Vₜᵢₚ of the rotary cutting tool 116 until the torque error T_{E} of the cutter motor 124 reaches zero value.

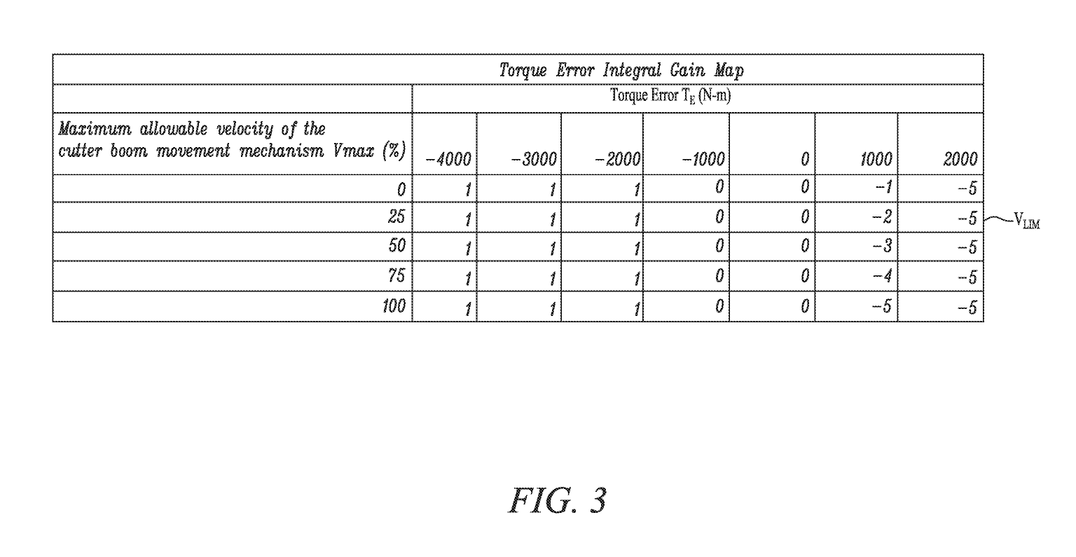

For instance, referring to the exemplary tabulation shown in FIG. 3, if the maximum allowable velocity V_{MAX} of the cutter boom movement mechanism 128 is set at the controller 206 to a value of 25%, and the torque error T_{E} between the load L_{M} on the cutter motor 124 and the adjusted cutter motor load limit L_{A} is about 1000 N-m i.e., L_{M} is in excess of L_{A} by 1000 N-m, then the speed limit factor V_{LIM} of −2 would be used by the controller 206 in decreasing the velocity V of the cutter boom movement mechanism 128 until the torque error T_{E} associated with current operation of the cutter motor 124 reaches zero value.

In an additional embodiment of this disclosure, it is further contemplated that when the controller 206 decreases the velocity V associated with the cutter boom movement mechanism 128, a rate R of decrease in the velocity V of the cutter boom movement mechanism 128 may be proportional to the amount of measured load L_{M} being in excess of the adjusted cutter motor load limit L_{A}. For example, referring again to the exemplary tabulation of FIG. 3, if the maximum allowable velocity V_{MAX} of the cutter boom movement mechanism 128 is set at the controller 206 to a value of 25%, and the torque error T_{E} between the load L_{M} on the cutter motor 124 and the adjusted cutter motor load limit L_{A} is about 2000 N-m i.e., L_{M} is in excess of L_{A} by 2000 N-m, then the speed limit factor V_{LIM} of −5 would be used by the controller 206 in decreasing the velocity V of the cutter boom movement mechanism 128 until the torque error T_{E} associated with current operation of the cutter motor 124 reaches zero value. In the foregoing example, the rate of decrease R which is defined by the speed limit factor V_{LIM} of −5 causes the velocity V of the cutter boom movement mechanism 128 to decrease more rapidly, say 70 rpm/sec, as compared to the rate of decrease R, say 50 rpm/sec when the speed limit factor V_{LIM} of −2 is applied corresponding to the torque error T_{E} being merely 1000 N-m as taken from the preceding example.

If the torque error T_{E} of the cutter motor 124 is indicative of the measured load L_{M} on the cutter motor 124 being less than the adjusted cutter motor load limit L_{A} i.e., if T_{E} is negative from L_{M}<L_{A}, then the controller 206 adjusts the velocity V associated with the cutter boom movement mechanism 128 by increasing the velocity V associated with the cutter boom movement mechanism 128.

For instance, referring again to the exemplary tabulation of FIG. 3, if the maximum allowable velocity V_{MAX} of the cutter boom movement mechanism 128 is set at the controller 206 to a value of 25%, and the torque error T_{E} between the load L_{M} on the cutter motor 124 and the adjusted cutter motor load limit L_{A} is about −2000 N-m i.e., L_{M} is less than L_{A} by 2000 N-m, then the speed limit factor V_{LIM} of 1 would be used by the controller 206 in increasing the velocity V of the cutter boom movement mechanism 128 until the torque error T_{E} associated with current operation of the cutter motor 124 reaches zero value.

In another instance, if the maximum allowable velocity V_{MAX} of the cutter boom movement mechanism 128 is set at the controller 206 to a value of 25%, and the torque error T_{E} between the load L_{M} on the cutter motor 124 and the adjusted cutter motor load limit L_{A} is about −4000 N-m i.e., L_{M} is less than L_{A} by 4000 N-m, then a similar speed limit factor V_{LIM} of 1 may, as shown in the exemplary tabulation of FIG. 3, be used by the controller 206 in increasing the velocity V of the cutter boom movement mechanism 128 until the torque error T_{E} associated with current operation of the cutter motor 124 reaches zero value.

With continued reference to the tabulation of FIG. 3, similar or dissimilar speed limit factors V_{LIM} have been contemplated for use by the controller 206 when decreasing the velocity V of the cutter boom movement mechanism 128 in each unique combination of the torque error T_{E} and the maximum allowable velocity V_{MAX} of the cutter boom movement mechanism 128 when the torque error T_{E} is in the positive range. It may be noted that these dissimilar speed limit factors V_{LIM} may in turn have correspondingly dissimilar rates R of decreases in the velocity V of the cutter boom movement mechanism when decreasing the velocity V of the cutter boom movement mechanism 128. However, as decreases in the velocity V of the cutter boom movement mechanism 128 may entail little or no upward loading of the cutter motor 124, the torque produced at the cutter motor 124 may be decreased, rapidly or slowly, as desired during an operation of the machine 100, for example, the torque produced from the cutter motor 124 may be reduced by merely reducing the amperage of Alternating Current (AC) supplied to the cutter motor 124 by the controller 206. Alternatively, in another example, if the cutter motor 124 is an AC drive motor that is provided with a Variable Frequency Drive (VFD) (not shown), then the torque produced from the cutter motor 124 may be easily reduced by sending appropriate command signals from the controller 206 for modulating a frequency and/or voltage of supplied current i.e., Alternating Current (AC) or Direct Current (DC) using the VFD.

However, although the same speed limit factor V_{LIM} of 1 is being implemented in increasing the velocity V of the cutter boom movement mechanism 128 for all unique combinations of the maximum allowable velocity V_{MAX} of the cutter boom movement mechanism 128 and the torque error T_{E} when the torque error T_{E} is in the negative range, particularly, when the torque error T_{E} is between −2000 N-m and −4000 N-m, it may be noted that the constant value of speed limit factor V_{LIM} of 1 would cause the controller 206 to ramp-up the velocity V of the cutter boom movement mechanism 128 as rapidly and steadily as possible taking into account various system design limitations. This way, the controller 206 may rapidly and steadily bring the cutter motor 124 into utilization at an optimum load value i.e., where T_{E}=0 for accomplishing maximum amount of productivity from the machine 100 during a mining operation.

In an embodiment of this disclosure, it has also been contemplated to configure the controller 206 to ignore small values of torque errors T_{E}, particularly, when the torque errors T_{E} are in the negative range, for example, when the T_{E} is −1000 N-m (refer to FIG. 3) as it is envisioned that such small differences in the amount of the measured load L_{M} and the adjusted cutter motor load limit L_{A} could result from a non-uniformity in the loading conditions presented by the face of the mine on the rotary cutting tool 116. This allows flexibility to the cutter motor 124 in operating the rotary cutting tool 116 at a torque value that is slightly lower than optimal for the given negligible torque error T_{E} of −1000 N-m but with an advantage of the cutter motor 124 being prepared, by way of its slightly lower than optimal torque being proximately disposed to the optimal loading range of the cutter motor 124, so that if an oncoming load in the cutting operation being performed on the face of the mine requires an imminent increase in the load of the rotary cutting tool 116 and the cutter motor 124, the torque of the cutter motor 124 can be easily increased through the narrow bandwidth of torque difference between its current torque value and a value at which the torque error T_{E} would be zero.

Although the tabulation of FIG. 3 discloses a specific value of the speed limit factor V_{LIM} for each unique combination of the maximum allowable velocity V_{MAX} of the cutter boom movement mechanism 128 and the torque error T_{E}, it may be noted that these values are non-limiting of this disclosure. Rather, the specific values of the speed limit factor V_{LIM} for each unique combination of the maximum allowable velocity V_{MAX} of the cutter boom movement mechanism 128 and the torque error T_{E} may be varied depending on specific requirements of an application.

In a further embodiment of this disclosure, upon adjusting the velocity V associated with the cutter boom movement mechanism 128, the controller 206 may also selectively adjust a current speed S_{current} of the cutter motor 124 in driving the rotary cutting tool 116. In one embodiment, the adjustment made by the controller 206 to the current speed S_{current} of the cutter motor 124 may be simultaneous with the adjustment made to the velocity V of the cutter boom movement mechanism 128. In another embodiment, the adjustment made by the controller 206 to the current speed S_{current} of the cutter motor 124 may be carried out in a tandem fashion with the adjustment made to the velocity V of the cutter boom movement mechanism 128.

In embodiments herein, if the controller 206 is configured to adjust the current speed S_{current} of the cutter motor 124, then the controller 206 may be advantageously configured to adjust the same based, at least in part, on the adjusted velocity V_{adjusted} of the cutter boom movement mechanism 128. For adjusting the current speed S_{current} of the cutter motor 124 in driving the rotary cutting tool 116, the controller 206 may determine if a cutter motor load control factor L_{F} is between a maximum load threshold value L_{MAX} and a minimum load threshold value L_{MIN}, each of the minimum and maximum load threshold values L_{MIN}, L_{MAX} being pre-defined to the controller 206 by way of additional user inputs, for example, user inputs 214 and 216 respectively. In one example, the minimum and maximum load threshold values L_{MIN}, L_{MAX} being pre-defined to the controller 206 may include 50% load and 100% load while the cutter motor load control factor L_{F} may be at about 60% (taking into account the maximum load percentage allowed for the cutter motor L_{MAX%} and the maximum amount of rated torque T_{MAX} available from the cutter motor 116). The scenario from the foregoing example would meet the requirements of the controller 206 for performing an adjustment to the current speed S_{current} of the cutter motor 124.

Before performing the adjustment to the current speed S_{current} of the cutter motor 124, the controller 206 may be further configured to determine if the cutter motor load control factor L_{F} is stable for a pre-determined period of time t, for example, two seconds. If so, the controller 206 may compute a desired cutter motor speed S_{desired} by multiplying a maximum nominal cutter motor speed S_{MAX} with a ratio between the velocity V associated with the cutter boom movement mechanism 128 prior to adjustment and the adjusted velocity V_{adjusted} of the cutter boom movement mechanism 128 i.e., S_{desired}=S_{MAX}*(V/V_{adjusted}) . . . Equation 5.

Upon determining the desired cutter motor speed S_{desired} from the foregoing equation 5, the controller 206 may adjust the current speed S_{current} of the cutter motor 124 so as to approach the desired cutter motor speed S_{desired}. This way, the controller 206 can optimize the current speed S_{current} of the cutter motor 124 to correspond with the adjusted velocity V_{adjusted} of the cutter boom movement mechanism 128 so that the rotary cutting tool 116 and the boom 108 co-operate to chop the materials off from the face of the mine as opposed to grinding these materials at the face of the mine. It is envisioned that when the cutter boom movement mechanism 128 moves with a high velocity, the cutter motor 124 would need to spin faster to keep the same amount of penetration of the rotary cutting tool 116 into the face of the mine during operation. Similarly, it is also envisioned that if the cutter boom movement mechanism 128 is moving with a low velocity, the cutter motor 124 would need to spin slower to keep the same tooth penetration / chunk size of the material being cut from the face of the mine.

However, if the controller 206 determines that the cutter motor load control factor L_{F} is unstable within the pre-determined period of time t, then the controller 206 is configured to facilitate a continuation in the operation of the cutter motor 124 at the current speed S_{current} without adjustment being made to the current speed S_{current} of the cutter motor 124.

Although equation 5 disclosed herein presents a linear relationship between the desired cutter motor speed S_{desired} and each of the maximum nominal cutter motor speed S_{MAX}, the velocity V associated with the cutter boom movement mechanism 128 prior to adjustment and the adjusted velocity V_{adjusted} of the cutter boom movement mechanism 128, the desired cutter motor speed S_{desired} may be obtained from one or more non-linear relationships with the maximum nominal cutter motor speed S_{MAX}, the velocity V associated with the cutter boom movement mechanism 128 prior to adjustment and the adjusted velocity V_{adjusted} of the cutter boom movement mechanism 128. For instance, such non-linear relationships between the desired cutter motor speed S_{desired} and the maximum nominal cutter motor speed S_{MAX}, the velocity V associated with the cutter boom movement mechanism 128 prior to adjustment and the adjusted velocity V_{adjusted} of the cutter boom movement mechanism 128 may be provided, for example, by way of a gain map pre-set at the controller 206 in which maximum and minimum desired cutter motor speed values S_{desiredmax} and S_{desiredmin} may be input before-hand for each unique combination of the maximum nominal cutter motor speed S_{MAX} and the ratio (V/V_{adjusted}). The controller 206 could use these maximum and minimum desired cutter motor speed values S_{desiredmax} and S_{desiredmin} as limits for the desired cutter motor speed S_{desired} so that the desired cutter motor speed S_{desired} for a given combination of the maximum nominal cutter motor speed S_{MAX} and the ratio (V/V_{adjusted}) lies within the pre-defined range of maximum and minimum desired cutter motor speed values S_{desiredmax} and S_{desiredmin} provided in the gain map.

The values of the maximum and minimum desired cutter motor speed values S_{desiredmax} and S_{desiredmin} disclosed herein may be pre-selected and fed before-hand to the controller 206 by way of the gain map based on various factors including, but not limited to, limitations associated with the performance of the cutter motor 124, the VFD, and/or other system design limitations. This way, when the controller 206 adjusts the current speed S_{current} of the cutter motor 124 to correspond with the adjusted velocity V_{adjusted} of the cutter boom movement mechanism 128, the controller 206 may also ensure that the cutter motor 124 is not driven too slowly or too quickly when the current speed S_{current} of the cutter motor 124 lies outside of the pre-defined range of the maximum and minimum desired cutter motor speed values S_{desiredmax} and S_{desiredmin} given the various factors taken into consideration when selecting the maximum and minimum desired cutter motor speed values S_{desiredmax} and S_{desiredmin} provided to the controller 206 by way of the gain map.

It is contemplated that speed and torque control of the cutter motor 124 for driving the rotary cutting tool 116 and/or for causing changes in the velocity V of the cutter boom movement mechanism 128 may be accomplished by the controller 206 using associated system hardware including, but not limited to, the Variable Frequency Drive (VFD) as disclosed earlier herein, or an application modifiable Field-Programmable Gate Array (FPGA). Such associated system hardware may be beneficially implemented to facilitate faster response when adjusting the speed and/or torque of the cutter motor 124, and/or for causing changes in the velocity V of the cutter boom movement mechanism 128.

The controller 206 disclosed herein could include various software and/or hardware components that are configured to perform functions consistent with the present disclosure. As such, the controller 206 of the present disclosure may be a stand-alone controller or may be configured to co-operate in conjunction with an existing electronic control unit (ECU) (not shown) of the machine 100 to perform functions consistent with the present disclosure. Further, the controller 206 may embody a single microprocessor or multiple microprocessors that include components for selectively and independently controlling operation of the cutter motor 124 and the cutter boom movement mechanism 128 based on the amount of load on the cutter motor 124 as sensed by the load sensor 202.

It should be appreciated that the controller 206 could readily be embodied in a general machine microprocessor capable of controlling numerous machine functions. The controller 206 may also include a memory (not shown), a secondary storage device, a processor, and any other components for running an application. Further, the controller 206 may also include suitable input devices, including but not limited to, Graphical User Interfaces (GUIs), for example, to facilitate operating personnel of the machine 100 to provide user inputs 202-214 to the controller 206. Various other circuits may be associated with the controller 206 such as power supply circuitry, signal conditioning circuitry, solenoid driver circuitry, and other types of circuitry. Also, various routines, algorithms, and/or programs can be programmed within the controller 206 for execution in the controller 206 to control an operation of the cutter motor 124 and the cutter boom movement mechanism 128 based on the sensed amount of load associated with the cutter motor 124.

FIG. 3 illustrates a flowchart depicting a method 400 having process steps 402-410 for controlling operation of the cutter motor 124 and the cutter boom movement mechanism 128, in accordance with an embodiment of the present disclosure. As shown, at step 402, the method 400 includes measuring the amount of load L_{M} associated with the cutter motor 124 in operation. At step 404, the method 400 further includes determining, by the controller 206, if there is a difference between the measured amount of load L_{M} on the cutter motor 124 and the derated cutter motor load limit L_{D} pre-defined to the controller 206. In doing so, the controller 206 may determine if there is a difference between the load L_{M} on the cutter motor 124 and the adjusted cutter motor load limit L_{A}.

If so, then the method 400 proceeds from step 404 to execute step 406. At step 406, the method 400 includes computing the torque error T_{E} of the cutter motor 124 from the difference between the measured amount of load L_{M} on the cutter motor and the derated cutter motor load limit L_{D}. In an embodiment of step 406, the method could beneficially include computing the torque error T_{E} of the cutter motor 124 from the difference between the measured amount of load L_{M} on the cutter motor and the adjusted cutter motor load limit L_{A}.

Upon computing the torque error T_{E}, at step 408, the method 400 includes adjusting the velocity V associated with the cutter boom movement mechanism 128 in moving the rotary cutting tool 116 relative to the tip velocity Vₜᵢₚ of the rotary cutting tool 116 based, at least in part, on the amount of torque error T_{E} until the torque error T_{E} of the cutter motor 124 reaches zero value i.e., T_{E}→0. Thereafter, the method 400 may proceed from step 408 to step 410 in which the method 400 may include adjusting the current speed S_{current} of the cutter motor 124 in driving the rotary cutting tool 116 based at least in part on the adjusted velocity V_{adjusted} of the cutter boom movement mechanism 128. It may be noted that the steps 408-410 may be carried out by the controller 206 independently or in combination.

Moreover, it may be noted that in an embodiment herein, when steps 408-410 are to be executed by the controller 206, the controller 206 may execute the steps 408-410 in a simultaneous manner. For example, when the load on the cutter motor 124 is greater than the adjusted cutter motor load limit L_{A}, the controller 206 may simultaneously decrease the velocity V of the cutter boom movement mechanism 128 and increase the current speed S_{current} of the cutter motor 124.

Alternatively, in another embodiment, when the steps 408-410 are to be executed by the controller 206, the controller 206 may execute such steps 408-410 in parallel. For example, when the load on the cutter motor 124 is greater than the adjusted cutter motor load limit L_{A}, the controller 206 may decrease the velocity V of the cutter boom movement mechanism 128 and subsequently increase the current speed S_{current} of the cutter motor 124.

Various embodiments disclosed herein are to be taken in the illustrative and explanatory sense, and should in no way be construed as limiting of the present disclosure. All joinder references (e.g., coupled, engaged, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functionality, such features may be omitted from the scope of the present disclosure without departing from the spirit of the present disclosure as defined in the appended claims.

### INDUSTRIAL APPLICABILITY

Embodiments of the present disclosure have applicability for use and implementation in independently and selectively controlling an operation of a cutter motor and a cutter boom movement mechanism of a machine. With implementation of control system 200 disclosed herein, speed and torque of the cutter motor 124 in driving the rotary cutting tool 116 and/or velocity of movement associated with the cutter boom movement mechanism 128 can be controlled to prevent overloading of the cutter motor 124 in operation while also maintaining an optimum performance of the machine 100 in chopping of the materials from the face of the mine as opposed to grinding the materials. This way, a service life of the cutters disposed on the rotary cutting tool may be prolonged and downtimes of the machine typically encountered with use of traditional control strategies may be minimized. Moreover, costs, effort, and time previously required in repair and overhaul of parts associated with the rotary cutting tool 116 may be reduced. Furthermore, with use of embodiments disclosed herein, an operational efficiency of the cutter motor 124 and/or the cutter boom movement mechanism 128 may be improved to achieve optimal productivity from the underground mining machine 100 during a mining operation.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. As used herein, “a” and “an” are intended to include one or more items, and may be used interchangeably with “one or more.” The term “one” or similar language is used when a single or only one item is intended. Also, as used herein, the terms “has,” “have,” “having,” or the like are intended to be open-ended terms. Further, the phrase “based on” is intended to mean “based, at least in part, on” unless explicitly stated otherwise. Such embodiments should be understood to fall within the scope of the present disclosure as determined based upon the claims and any equivalents thereof.

What is claimed is:

1. A control system for controlling operation of a cutter motor and a cutter boom movement mechanism associated with a rotary cutting tool of a machine, the control system comprising:
at least one sensor disposed on the machine and associated with the cutter motor, the at least one sensor configured to measure an amount of load associated with the cutter motor in operation; and
a controller disposed in communication with the at least one sensor, the cutter motor, and the cutter boom movement mechanism, the controller being configured to:
determine whether the amount of load on the cutter motor measured by the at least one sensor is different than a cutter motor load limit, and
when the amount of load on the cutter motor is different than the cutter motor load limit:
adjust a velocity associated with the cutter boom movement mechanism in moving the rotary cutting tool relative to a velocity of a portion of the rotary cutting tool based on a torque error of the cutter motor computed by the controller,
the torque error being computed based on a difference between the amount load on the cutter motor and the cutter motor load limit,
the velocity being adjusted until the torque error of the cutter motor reaches a particular value; and
selectively adjust a current speed of the cutter motor in driving the rotary cutting tool based on the adjusted velocity of the cutter boom movement mechanism.

2. The control system of claim 1, wherein the controller is configured to compute:
a derated cutter motor load limit for the cutter motor by multiplying a maximum amount of rated torque available from the cutter motor with a torque derate factor; and
an adjusted cutter motor load limit for the cutter motor from the derated cutter motor load limit by multiplying the derated cutter motor load limit with a maximum load percentage allowed for the cutter motor, the maximum load percentage allowed for the cutter motor being defined by a user input.

3. The control system of claim 2, wherein, when determining whether the amount of load on the cutter motor measured by the at least one sensor is different than the cutter motor load limit, the controller determine whether the amount of load on the cutter motor is different than the adjusted cutter motor load limit.

4. The control system of claim 2, wherein the controller determines the torque error based on a difference between the amount of load on the cutter motor and the adjusted cutter motor load limit.

5. The control system of claim 2, wherein the controller is configured to determine a speed limit factor based on the torque error and a maximum allowable velocity of the cutter boom movement mechanism, the maximum allowable velocity of the cutter boom movement mechanism being provided to the controller by way of an input command.

6. The control system of claim 5, wherein the controller is configured to adjust the velocity associated with the cutter boom movement mechanism relative to the velocity of the portion of the rotary cutting tool, based on the determined speed limit factor until the torque error reaches the particular value of zero, and wherein the velocity of the portion of the rotary cutting tool, being used to compare with the velocity associated with the cutter boom movement mechanism during adjustment, is a tip velocity of the rotary cutting tool.

7. The control system of claim 4, wherein, if the torque error of the cutter motor indicates that the amount of load on the cutter motor is greater than the adjusted cutter motor load limit, the controller decreases the velocity associated with the cutter boom movement mechanism until the torque error of the cutter motor reaches the particular value.

8. The control system of claim 7, wherein the particular value is zero.

9. The control system of claim 7, wherein a rate of decrease in the velocity associated with the cutter boom movement mechanism is proportional to the amount of load measured by the sensor being in excess of the adjusted cutter motor load limit.

10. The control system of claim 4, wherein, if the torque error of the cutter motor indicates that the measured load on the cutter motor is less than the adjusted cutter motor load limit, the controller is configured to adjust the velocity associated with the cutter boom movement mechanism by increasing the velocity associated with the cutter boom movement mechanism.

11. The control system of claim 1, wherein the controller is configured to adjust the current speed of the cutter motor in driving the rotary cutting tool by:
determining if a cutter motor load control factor is between a minimum threshold value and a maximum threshold value, each of the minimum and maximum threshold values being pre-defined to the controller; and
determining if the cutter motor load control factor is stable for a pre-determined period of time, and if so:
computing a desired cutter motor speed by multiplying a maximum nominal cutter motor speed with a ratio between the velocity associated with the cutter boom movement mechanism prior to adjustment and the adjusted velocity of the cutter boom movement mechanism; and
adjusting the current speed of the cutter motor so as to approach the desired cutter motor speed.

12. The control system of claim 9, wherein, if the controller determines that the cutter motor load control factor is unstable within the pre-determined period of time, the controller is configured to facilitate a continuation in the operation of the cutter motor at the current speed without adjustment being made to the current speed of the cutter motor.

13. A machine comprising:
a frame;
a rotary cutting tool pivotally supported on the frame and operably moveable in relation to the frame by a cutter boom movement mechanism;
a cutter motor disposed on the frame and associated with the rotary cutting tool; and
a controller configured to:
determine whether an amount of load on the cutter motor is different than a cutter motor load limit, and
when the amount of load on the cutter motor is different than the cutter motor load limit:
adjust a velocity associated with a cutter boom movement mechanism in moving the rotary cutting tool relative to a velocity of a portion of the rotary cutting tool based on a torque error of the cutter motor,
the cutter boom movement mechanism being associated with a rotary cutting tool,
the torque error being computed based on a difference between the amount load on the cutter motor and the cutter motor load limit,
the velocity being adjusted until the torque error of the cutter motor reaches a particular value; and
selectively adjust a current speed of the cutter motor in driving the rotary cutting tool based on the adjusted velocity of the cutter boom movement mechanism.

14. The machine of claim 11, wherein the controller is to adjust a current speed of the cutter motor,
when adjusting the current, the controller is configured to:
determine if a cutter motor load control factor is between a minimum threshold value and a maximum threshold value, each of the minimum and maximum threshold values being pre-defined to the controller; and
determine if the cutter motor load control factor is stable for a pre-determined period of time, and
when the cutter motor load control factor is stable for the pre-determined period of time:
compute a desired cutter motor speed by multiplying a maximum nominal cutter motor speed with a ratio between the velocity associated with the cutter boom movement mechanism prior to adjustment and the adjusted velocity of the cutter boom movement mechanism, and
adjust the current speed of the cutter motor so as to approach the desired cutter motor speed.

15. A method for controlling operation of a cutter motor and a cutter boom movement mechanism associated with a rotary cutting tool of a machine, the method comprising:
measuring, using at least one sensor, an amount of load associated with the cutter motor in operation; and
determining, by a controller communicably coupled to the at least one sensor, the cutter motor and the cutter boom movement mechanism, if the load on the cutter motor is different from a derated cutter motor load limit, and if so:
computing a torque error of the cutter motor, by the controller, from the difference between the measured amount of load on the cutter motor by the at least one sensor and the cutter motor load limit;
adjusting, by the controller, a velocity associated with the cutter boom movement mechanism in moving the rotary cutting tool relative to a tip velocity of the rotary cutting tool based, at least in part, on the amount of torque error until the torque error of the cutter motor reaches zero value; and
selectively adjusting, by the controller, a current speed of the cutter motor in driving the rotary cutting tool based at least in part on the adjusted velocity of the cutter boom movement mechanism.

16. The method of claim 15 further comprising computing by the controller:
a derated cutter motor load limit for the cutter motor by multiplying a maximum amount of rated torque available from the cutter motor with a pre-defined motor torque derate factor; and
an adjusted cutter motor load limit for the cutter motor from the derated cutter motor load limit by multiplying the derated cutter motor load limit with a maximum load percentage allowed for the cutter motor, the maximum load percentage allowed for the cutter motor being pre-defined to the controller by an user input.

17. The method of claim 16, wherein determining whether the load on the cutter motor is different from the cutter motor load limit includes determining whether the amount of load on the cutter motor as measured by the at least one sensor is different from the adjusted cutter motor load limit.

18. The method of claim 16 further comprising determining, by the controller, the torque error from the difference between the load on the cutter motor and the adjusted cutter motor load limit.

19. The method of claim 18 further comprising:
determining, by the controller, a speed limit factor based on the torque error and a maximum allowable velocity of the cutter boom movement mechanism, the maximum allowable velocity of the cutter boom movement mechanism being provided to the controller by way of an input command; and
adjusting the velocity associated with the cutter boom movement mechanism, by the controller, on the basis of the determined speed limit factor.

20. The method of claim 19, wherein:
if the torque error of the cutter motor is indicative of the measured load on the cutter motor being greater than the adjusted cutter motor load limit, then the method includes decreasing the velocity associated with the cutter boom movement mechanism, by the controller, until the torque error of the cutter motor reaches the particular value, the particular value being zero; and
if the torque error of the cutter motor is indicative of the measured load on the cutter motor being less than the adjusted cutter motor load limit, then the method includes increasing the velocity associated with the cutter boom movement mechanism by the controller.
